(19) United States
(12) Patent Application Publication
(10) Pub. No.: US 2002/0021071 A1
(43) Pub. Date: Feb. 21, 2002

(54) Rail in flat type cathode ray tube

(76) Inventors: Jun-Tae Jeon, Kyongsangbuk-do (KR); Hyun-Joon Jeong, Kyongsangbuk-do (KR)

Correspondence Address: FLESHNER & KIM, LLP, P.O. Box 221200, Chantilly, VA, 20153-1200, US

(21) Appl. No.: 09/855,523

(22) Filed: May 16, 2001

(30) Foreign Application Priority Data
May 17, 2000 (KR) 2000-26312
Nov. 24, 2000 (KR) 2000-70561

(51) Int. Cl. H01J 29/80

(52) U.S. Cl. 313/402; 313/407

(57) ABSTRACT

Disclosed is a rail in flat type CRT(Cathode Ray Tube). The a rail in flat type CRT includes a bulb on which a panel and a funnel are attached; and a rail attached and adhered on an inner surface of the panel for welding a shadow mask in a tension state, the shadow mask serving for a color selection function, wherein the rail is formed by combining two long shafts and two short shafts having a predetermined width and has round parts formed at edge portions of the rail to endure stress due to heat expansion. Therefore, even though the flat type CRT is manufactured by repeatedly performing the motion that the rails, on which the shadow mask is welded, is connected to the inner surface of the panel and passes through the inside of the furnace of high temperature, it is prevented that cracks due to the heat expansion and the stress generated in the longitudinal direction of the rails made of metal are generated at the panel side, on which the rail is attached and adhered, and it is restricted that bad products are manufactured.

### BACKGROUND OF THE INVENTION

1. Field of the Invention

5 The present invention relates to a rail in flat type CRT (Cathode Ray Tube), and more particularly, to a rail in flat type CRT capable of preventing an occurrence of cracks in a panel side of attached points of edge portions of the rail due to heat expansion generated in a longitudinal direction of the rail made of metal and stress because of this and capable of lowering a defective proportion of products even though the flat type CRT is manufactured by repeating several times a motion that the rail on which a shadow mask is welded is attached and adhered on an inner surface of the panel passes through the inside of a furnace of high temperature.

2. Description of the Related Art

FIG. 1 is a sectional view showing an inner structure of a conventional flat type CRT (Cathode Ray Tube).

As shown in FIG. 1, the conventional flat type CRT includes a panel 1 having a flame-proof glass 2 of a flame-proof property at a front surface, a funnel 3 attached to a rear surface of the panel 1 and an electron gun 4 inserted and sealed into a neck part, i.e., narrow part, of the funnel 3 for emitting three e-beams 5 of R(Red), G(Green) and B(Blue) colors toward the panel 1.

An inner surface of the panel I is coated with a luminescent screen 6 radiating the colors by the e-beams 5, on which the three colors of R, G and B are coated. A shadow mask 7 having a plurality of fine holes is mounted in a regular interval from the inner surface of the panel 1 coated with the luminescent screen 6.

In the flat type CRT having the panel 1 of flat type, the shadow mask 7 is supported by a rail assembly 9 is attached on the panel 1. As shown in FIG. 2a, the rail assembly 9 is in the form of a rectangular frame formed by combining two long shafts 8a and two short shafts 8b, and attached and fixed on the panel 1 by a frit glass 10.

Here, contact surfaces of the rails 8a and 8b form a diagonal at corner portions where front ends of the long shaft rails 8a and of the short shaft rails 8b are contacted with each other, and the front ends of the rails 8a and 8b are attached to each other by a surface welding method.

A manufacturing process of the flat type CRT having the above structure will be described as follows.

First, the two long shafts and two short shafts of the rail 8 are combined in the rectangular frame shape and edge portions are cut to prevent interference with the funnel 3.

The rail 8 of which edge portions are cut is accorded to the frit glass coated on an inner surface of the panel 1 and attached and adhered on the inside a furnace of high temperature.

If the attaching process of the rail 8 to the panel 1 is finished, the shadow mask 7 is fixed on the rail 8 to maintain a tension state. After that, the rail 8 is inserted again into the furnace of high temperature to resolve organic compound contained in the luminescent screen 6 coated on the panel 1.

If the resolution process of organic compound contained in the luminescent screen 6 is finished, the panel 1 and the funnel 3 are accorded to each other through the frit glass attached and adhered in the inside of the furnace of high temperature.

If the adhering process is finished, the electron gun 4 is inserted into the neck part of the funnel 3. After that, an exhaust step is performed, that is, a bulb (or tube), which connects the panel 1 and the funnel 3, passes through the inside of the furnace of high temperature so that the inner pressure maintain a high vacuum condition of 10⁻⁷ torr.

After that, a reinforced band for ensuring the flame-proof property is fixed, and thereby the flat type CRT manufacture is finished.

However, the following problems are generated during manufacturing the flat type CRT through the above steps.

That is, to manufacture the flat type CRT as the above, in the state that the rail 8 on which the shadow mask 7 is welded is connected to the inner surface of the panel 1, the rail 8 repeatedly passes through the inside of the furnace of high temperature several times. At this time, as shown in FIGS. 4a and 4b, there are generated cracks (indicated as a solid line in the drawings), which extends from the contact surfaces of the rails 8a and 8b, at panel 1 portions contacting with the edge portions of the rails 8a and 8b, due to a difference in heat expansion/contraction rate between the rails 8a and 8b and the panel 1.

Furthermore, there is generated stress concentration phenomenon at the panel 1 and the corner portions where the long shaft rails 8a and the short shaft rails 8b are contacted with each other, due to differences in heat stress unbalance and elongation ratio between the rails 8a and 8b and the panel 1, which are generated by rapidly heating/cooling the panel 1 in the step of coating phosphor particle to form the luminescent screen 6 on the inner surface of the panel 1.

According to such stress concentration phenomenon, compressed stress is generated at the comer portions where the long and short shaft rails 8a and 8b are contacted with each other and tension stress is generated at specific portions of the panel 1 contacted to the comer portions. As shown in FIGS. 4c and 4d, semicircular cracks, which extend from the comer portion (indicated as the solid line in the drawings), are generated in the panel 1.

The panel 1, in which the cracks are generated, does not fulfill its function and cannot used. Therefore, the rail attaching step and the coating step the luminescent screen are performed again on a new panel to assemble the CRT.

That is, in the relate art, because there is a high possibility that cracks are generated in the panel 1 due to the structural property of the rail, the defective proportion of the products is increased during the manufacturing process of the CRT and the product cost is raised.

### SUMMARY OF THE INVENTION

Accordingly, the present invention is directed to a rail in flat type CRT (Cathode Ray Tube) that substantially solves the problems generated during manufacturing the flat type CRT by repeatedly performing a plasticity process to a panel, on which the rail is attached and adhered, in the inside of a furnace of high temperature.

It is an object of the present invention to provide a rail in flat type CRT capable of preventing an occurrence of cracks in a panel side of attached points of edge portions of the rail due to heat expansion generated in a longitudinal direction of the rail made of metal and stress because of this and capable of lowering a defective proportion of products even though the flat type CRT is manufactured by repeating several times a motion that the rail on which a shadow mask is welded is attached and adhered on an inner surface of the panel passes through the inside of a furnace of high temperature.

It is another object of the present invention to provide a rail in flat type CRT capable of restricting occurrence of bad products during the manufacturing process of the flat type CRT and capable of lowering the product cost.

To achieve the above objects, the present invention provides a rail in flat type CRT (Cathode Ray Tube) including: a bulb on which a panel and a funnel are attached; and a rail attached and adhered on an inner surface of the panel for welding a shadow mask in a tension state, the shadow mask serving for a color selection function, wherein the rail is formed by combining two long shafts and two short shafts having a predetermined width and has round parts formed at edge portions of the rail to endure stress due to heat expansion.

It is preferable that the round parts are larger than a width of the rail having the long shafts and the short shafts and smaller than a curvature of an inner surface of the funnel.

It is preferable that the radius R of the round part is larger than the width L of the rail having the long shafts and the short shafts and the radius R of the round part and the width L of the rail satisfy the following formula:

1.08≦R/L≦1.55.

Moreover, it is preferable that the rail formed by combining the long shafts and the short shafts has a section of“L” character.

Contact portions where the rail shafts are contacted to each other are in the form of a curve and outside of corner portions formed by contacting the rail shafts to each other have a sunken form.

Here, on a surface of the panel, on which the rail is attached and adhered, line grooves are formed in longitudinal direction.

A rail assembly of the present invention includes an end cap wrapping the comer portions where the rail shafts are conjugated.

### BRIEF DESCRIPTION OF THE DRAWINGS

Further objects and advantages of the invention can be more fully understood from the following detailed description taken in conjunction with the accompanying drawings in which:

FIG. 1 is a sectional view showing an inner structure of a conventional flat type CRT (Cathode Ray Tube) applied to the present invention;

FIG. 2a is a front view showing a rail structure for fixing a shadow mask in a conventional flat type CRT;

FIG. 2b is a sectional view showing the rail structure for fixing the shadow mask in the conventional flat type CRT;

FIG. 3a is a front view showing a rail structure for fixing a shadow mask in a flat type CRT according to the present invention;

FIG. 3b is a sectional view showing the rail structure for fixing the shadow mask in the flat type CRT according to the present invention;

FIGS. 4a through 4d are plan views showing structures of a rail assembly of the conventional flat type CRT and shapes of cracks generated in a panel;

FIG. 5 is a plan view showing a structure of a rail assembly according to an embodiment of the present invention; and

FIG. 6 is a rear view showing the structure of the rail assembly according to the embodiment of the present invention.

### DETAILED DESCRIPTION OF THE PREFERRED EMBODIMENT

With reference to the accompanying drawings, the present invention will now be described in detail. In the description on the present invention, the same reference characters are given to the same components and elements as in the conventional art.

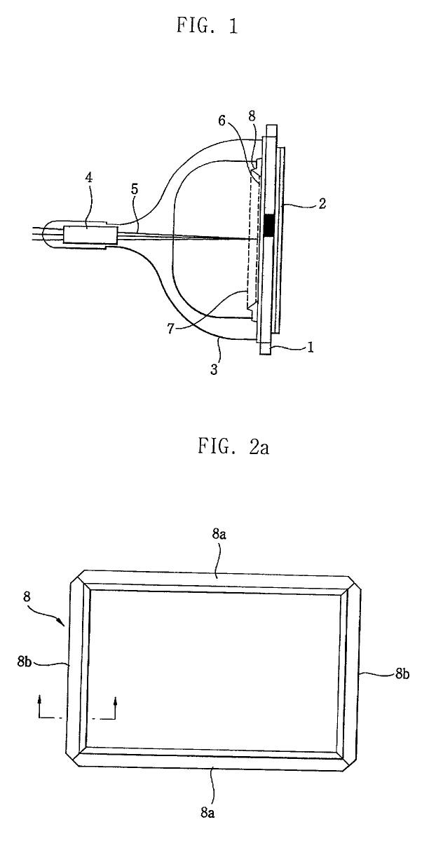

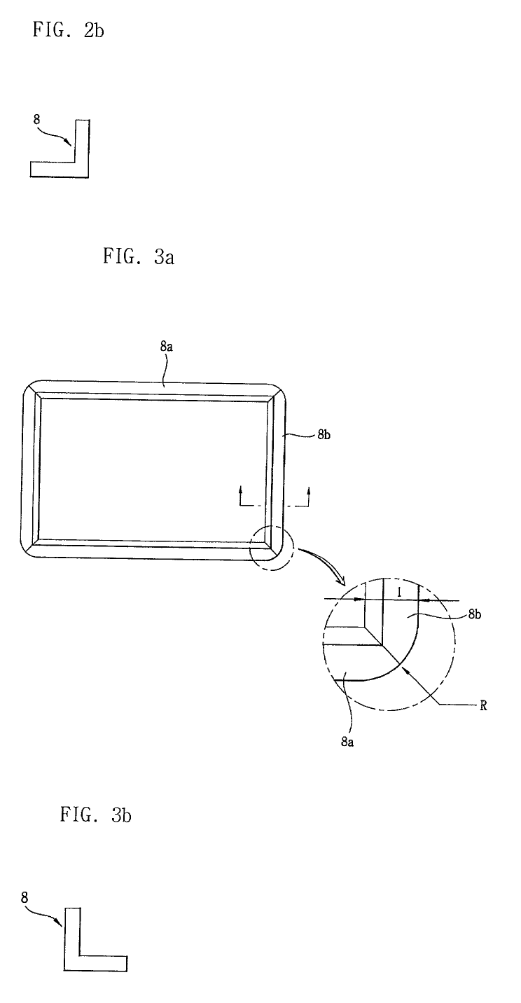

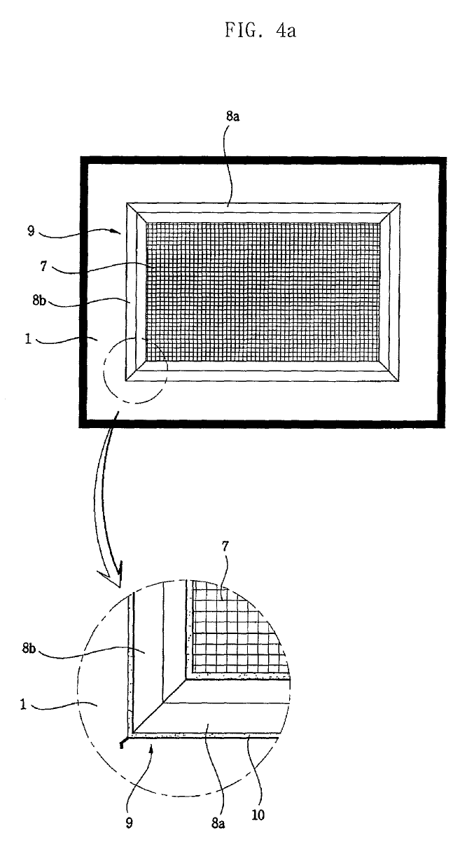

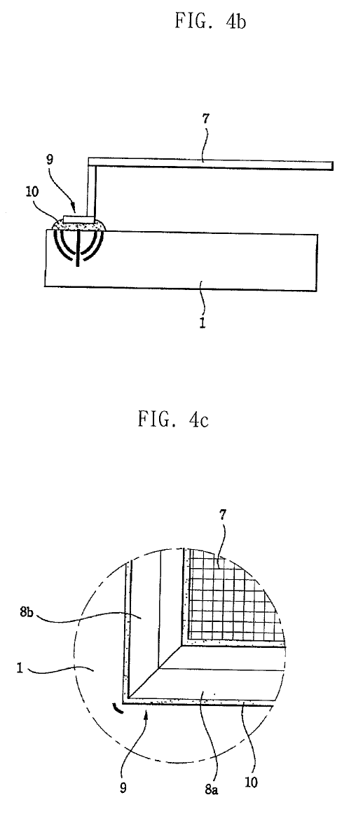

FIG. 1 is a sectional view showing an inner structure of a conventional flat type CRT (Cathode Ray Tube) applied to the present invention. FIGS. 3a and 3b are a front view and a sectional view respectively showing a rail structure for fixing a shadow mask in a flat type CRT according to the present invention.

As shown in the drawings, the flat type CRT applied to the present invention includes a panel 1 having a flame-proof glass 2 of a flame-proof property at a front surface, a funnel 3 having a front portion attached to a rear surface of the panel 1 and an electron gun 4 inserted and sealed into a neck part, i.e., narrow part, of the funnel 3 for emitting e-beams 5.

An inner surface of the panel 1 is coated with a luminescent screen 6 radiating three colors of R, G and B by the e-beams 5 on which the three colors are coated and emitted. A shadow mask 7 having a plurality of fine holes is mounted in a regular interval from the inner surface of the panel 1 coated with the luminescent screen 6.

As shown in FIGS. 3a and 3b, the shadow mask 7 is welded on a rail 8 in a tension state after two long shafts 8a and two short shafts 8b are combined to form a rectangular frame shape and the rail is attached and adhered on an inner surface of the panel 1. The structure is the same as a conventional flat type CRT.

A manufacturing process of the flat type CRT having the above structure will be described as follows. First, the two long shafts 8a and the two short shafts 8b are combined to form the rectangular frame shape and then attached on the inner surface of the panel 1. Four edge portions of the rail 8 have round parts(R) for preventing interference to an inner surface of the funnel 3 when the funnel is assembled.

It is also possible that each end portion of the long and short shafts 8a and 8b is manufactured to have the round part(R) and combined in the form of the rectangular frame or the long and short shafts 8a and 8b are combined with each other and cut to form the round parts(R).

The rail 8 having the round parts(R) formed at the edge portions is accorded to a frit glass coated on an inner surface of the panel 1, and then, attached in the inside of a furnace of high temperature.

If the attaching process of the rail 8 to the panel 1 is finished, the shadow mask 7 is fixed on the rail 8 to maintain a tension state. The rail 8 is inserted again into the furnace of high temperature to resolve organic compound contained in the luminescent screen 6 coated on the panel 1.

If the resolution process of organic compound contained in the luminescent screen 6 is finished, the panel 1 and the funnel 3 are accorded to each other through the frit glass and attached and adhered in the inside of the furnace of high temperature.

A feature of the present invention is that the stress due to heat expansion is not concentrated at the edge portions even though the plasticity process is performed several times by the rail 8 of the present invention having a structure that the edge portions of the rail 8, i.e., both ends of the long shafts 8a and of the short shafts 8b, have the round faces which correspond each other, and this round faces are contacted to each other and form the edge portions of the rail 8 having the round portion(R).

In the state that the rail 8 having the long shafts 8a and the short shafts 8b are combined with each other to the rectangular frame shape, to define a range of shapes of the round parts(R) of the edge portions, experimentation was carried out and the following result was obtained.

TABLE 1

| Shape of round part | Bulb crack generating rate in furnace process |
|---|---|
| (R) of edge portion | (Badness No./Input No.) |
| R 3.4 | 7.4% (10/41) |
| R 5.0 | 10.4% (5/48) |
| R 6.3 | 4.3% (2/46) |
| R 8.0 | 1.9% (1/52) |

Conditions for the above experiment are as follows. The width (L) of the long shafts 8a and the short shafts 8b is 5.8 mm and the bulb crack generating rate capable of being applied to the flat type CRT is less than 5%.

Therefore, the shape of the round parts(R) of the edge portions of the rail 8 having a structure of “L” character in sectional, must be larger than 5.8 mm, which is the width of the rail 8. When the stress acts to the bulb during the plasticity process performed in the inside of the furnace of high temperature several times, the stress is concentrated on each edge portion from the long shafts 8a and the short shaft 8b sides, at this time the bulb crack acts in a vertically direction to a stress acting direction. Therefore, to overcome the stress and to prevent the bulb crack, a coated interval of the frit glass of each edge portion, on which the stress is concentrated, must be wider than that of the frit glass in a longitudinal direction of the long shafts 8a and the short shafts 8b of the rail 8.

Furthermore, if the round parts(R) of the edge portions are equal to the inner surface curvature of the funnel 3 or more than 9.0 mm, there occurs a problem that each edge portion interferes with the frit glass comer part coated on the funnel 3 and each comer portions during the attaching process of the panel 1 and the funnel 3 in the furnace of high temperature using the frit glass.

Therefore, the radius R of the round parts of each edge portion must be larger than the width L of the rail and smaller than 9.0 mm. That is, the following formula must be satisfied.

R/L≦1.55

In more preferable, the relationship between the radius(R) of the round part and the width (L) of the rail must satisfy the following formula.

1.08≦R/L≦1.55

The rail is made by combining the long shafts and the short shafts: either the long shaft or the short shaft has an end portion of a convex form and either the short shaft or the long shaft which is combined with the long shaft or the short shaft has an end portion of a convex form has an end portion of a concave form.

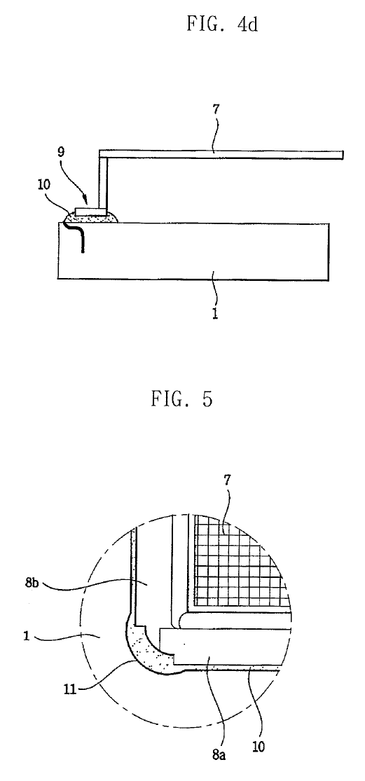

As shown in FIG. 5, outside of corner portions formed by contacting the rails 8a and 8b to each other have a sunken form.

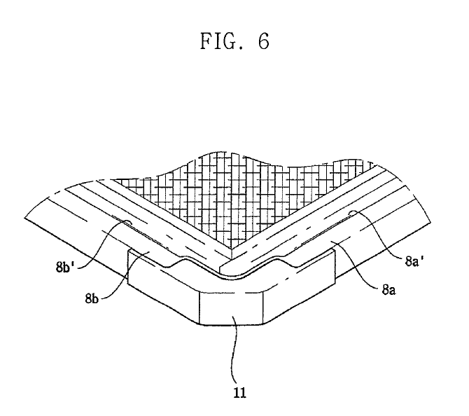

Here, line grooves 8a′ and 8b′ formed in the surface of the rail is attached to the panel, in a longitudinal direction (see FIG. 6).

A rail assembly 9 according to the embodiment of the present invention includes an end cap 11 wrapping the comer portion where the rails 8a and 8b are contacted to each other. The end cap 11 is a band type member, which is bent at determined angles. The end cap 11 has an end attached to the front end of the long shaft rails 8a and the other end attached to the front end of the short shaft rails 8b.

According to the embodiment of the present invention, in the step that each rail 8a is attached on the panel 1 by heat through the frit glass 10, the stress concentrated on the combined portion of the rails 8a and 8b due to the difference in heat expansion/contraction rate between the rails 8a and 8b and the panel 1 is reduced by the structure of the comer portion and by the reduction of the attached surface between the rails 8a and 8b and the panel 1. Therefore, there do not occur cracks in the panel 1 during the rail attaching process.

Moreover, in the step of forming the luminescent screen 6 (see FIG. 1) in the inside of the panel 1, the stress concentration due to the change of the length of the rails 8a and 8 b generated by rapidly heating/cooling the panel 1 does not occur at the comer portion. According to the structure of the rails 8a and 8b having the line grooves 8a′ and 8b′, the contact surface between the panel 1 and the rails 8a and 8b is reduced, thereby reducing an amount of the frit glass 10 used.

The end cap 11 prevents the frit glass from excessively flowing to the contour of the rails 8a and 8b and prevents occurrence of cracks in the panel 1 due to badness in shape of the frit glass 10.

For your reference, if the shape is deteriorated due to the frit glass 10, which is excessively thin or thick, the stress is not distributed evenly, thereby having bad influence on the rails 8a and 8b and generating cracks in the panel 1.

As previously described, according to the rail in the flat type CRT of the present invention, even though the flat type CRT is manufactured by repeatedly performing the motion that the rails, on which the shadow mask is welded, is connected to the inner surface of the panel and passes through the inside of the furnace of high temperature, it is prevented that cracks due to the heat expansion and the stress generated in the longitudinal direction of the rail made of metal are generated at the panel side, on which the rails are attached and adhered.

Moreover, it is restricted that bad products are manufactured during the manufacturing process of the flat type CRT, thereby lowering the product cost.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A rail in flat type CRT(Cathode Ray Tube) comprising:
a bulb on which a panel and a funnel are attached; and
a rail attached and adhered on an inner surface of the panel for welding a shadow mask in a tension state, the shadow mask serving for a color selection function,
wherein, the rail is formed by combining two long shafts and two short shafts having a predetermined width and has round parts formed at edge portions of the rail to endure stress due to heat expansion.

2. The rail as claimed in claim 1, wherein the round parts are larger than a width of the rail having the long shafts and the short shafts and smaller than a curvature of an inner surface of the funnel.

3. The rail as claimed in claim 1, wherein the radius of the round part is larger than the width of the rail having the long shafts and the short shafts and the radius R of the round part and the width L of the rail satisfy the following formula:
R/L≦1.55.

4. The rail as claimed in claim 3, wherein the radius R of the round part and the width L of the rail satisfy the following formula:
1.08≦R/L≦1.55.

5. The rail as claimed in claim 1, wherein the rail formed by combining the long shafts and the short shafts has a section of “L” character.

6. The rail as claimed in claim 1, wherein the rail formed by combining the two long shafts and the two short shafts having the determined width, either the long shaft or the short shaft has an end portion of a convex form and either the short shaft or the long shaft which is combined with the long shaft or the short shaft has an end portion of a convex form has an end portion of a concave form.

7. The rail as claimed in claim 1, wherein outside of comer portions formed by contacting the rails to each other have a sunken form.

8. The rail as claimed in claim 1, further comprising line grooves formed in the surface of the rail is attached to the panel, in a longitudinal direction.

9. The rail as claimed in claim 1, further comprising an end cap wrapping the corner portions where the rail shafts are conjugated.
